(19) United States
(12) Patent Application Publication
(10) Pub. No.: US 2003/0073014 A1
(43) Pub. Date: Apr. 17, 2003

(54) Electrophotographic photoreceptor and electrophotographic apparatus using same

(76) Inventors: Sayaka Fujita, Kashihara-shi (JP); Masanori Matsumoto, Kashihara-shi (JP); Koichi Toriyama, Osaka (JP); Satoshi Katayama, Nabari-shi (JP); Masayuki Sakamoto, Nabari-shi (JP); Akihiko Kawahara, Nara-shi (JP)

Correspondence Address: NIXON & VANDERHYE P.C., 8th Floor, 1100 North Glebe Road, Arlington, VA, 22201, US

(21) Appl. No.: 10/105,629

(22) Filed: Mar. 26, 2002

(30) Foreign Application Priority Data
Mar. 26, 2001 (JP) P2001-88464

(51) Int. Cl. G03G 5/14; G03G 15/10

(52) U.S. Cl. 430/65; 430/69

(57) ABSTRACT

An object of the invention is to provide a multi-layered type electrophotographic photoreceptor in which a low-cost porthole tube is used as an electrically conductive support, and an electrophotographic apparatus using the electrophotographic photoreceptor. In the electrophotographic photoreceptor having the multi-layered type photosensitive layer, the porthole tube is used as the electrically conductive support, and an undercoat layer containing titanium oxide and a polyamide resin is provided between the porthole tube and the photosensitive layer.

### BACKGROUND OF THE INVENTION

1. Field of the Invention

The present invention relates to an electrophotographic photoreceptor for use in an electrophotographic apparatus such as a copying machine, a laser printer and the like and an electrophotographic apparatus provided with the electrophotographic photoreceptor.

2. Description of the Related Art

Heretofore, an electrically conductive support in a cylindrical shape comprising aluminum and the like has ordinarily been used in an electrophotographic photoreceptor to be provided in an electrophotographic apparatus. Further, in order to realize stability of characteristics, low cost, an easily disposable property and the like, an organic photosensitive material comprising an organic photosensitive layer formed on an outer surface of the electrically conductive support has widely been used.

As the organic photosensitive material, a photosensitive material that allows different substances therein to respectively bear an electric charge generating function and an electric charge transferring function which are important factors for a photosensitive layer to exert a photoconductive function has been proposed. As far as the photosensitive layer is concerned, there are two types, that is, a single-layer type and a multi-layered type. On this occasion, the single-layer type as herein used indicates the photosensitive layer constituted by a single layer in which an electric charge generating substance and an electric charge transferring substance are mixed and dispersed, while the multi-layered type as herein used indicates the photosensitive layer constituted by a plurality of photosensitive layers whereupon the electric charge generating substance and the electric charge transferring substance are separately dispersed in an electric charge generating layer and an electric charge transferring layer, respectively.

The cylindrical electrically conductive support can be prepared by subjecting a starting material such as a 1000 (pure aluminum) type, a 3000 (Al—Mn) type, a 5000 (Al—Mg) type or a 6000 (Al—Mg—Si) type of aluminum or an alloy thereof to rolling, extruding or other processing allowing it to be in a cylindrical (drum) shape.

Specifically, there have been known methods: (1) a method (DI method) in which the starting material is subjected to deep-drawing processing to allow it to be formed in a cup shape and, then, a wall of the thus-deep drawn material in the cup shape is subjected to ironing processing allowing it to be expanded whereupon a cylinder having a bottom portion is prepared; (2) a method (II method) in which the starting material is subjected to impact extrusion processing allowing it to be formed in a cup shape and, then, a wall of the thus-impact extruded material in the cup shape is subjected to ironing processing allowing it to be expanded whereupon a cylinder having a bottom portion is prepared; (3) a method (EI method) in which the starting material is subjected to extrusion processing to prepare a cylinder and, then, the thus-prepared cylinder is subjected to ironing processing whereupon a thin-wall cylinder is prepared; (4) a method (ED method) in which the cylinder which has been prepared by the extrusion processing as described above is further subjected to drawing processing whereupon another thin-wall cylinder is prepared; and (5) a method in which a cylinder prepared by any one of from (1) to (4) methods described above is further subjected to cutting processing and the like. Among these methods, in a method in which the cylinder that has been prepared by the EI method, the ED method or the both is further subjected to the cutting processing, the extrusion processing has been performed between these processing as a middle step.

As a method of preparing a hollow pipe (cylinder) by the extrusion processing, there have been known a mandrel method and a porthole method. The mandrel method is a method in which firstly a mandrel is attached to a leading end of a stem of an extruder and, then, the mandrel is processed as a core cylinder to prepare the hollow pipe; however, this method has a drawback that a thickness deviation is likely to be generated in the hollow pipe, it is difficult to permit the hollow pipe to be thin or the like. While, the porthole method is a method in which a metal as a starting material is once separated in a mold and, then, combined again to prepare the hollow pipe; on this occasion, though this method is superior to the mandrel method on the points of an extent of the thickness deviation and capability of being small in thickness, this method has a drawback that there remains a mark (seam, weld line) thereon which is generated when the metal once separated is combined again. This weld line tends to cause a defect in a streak pattern in an image.

It is considered that this defect in the image is generated by uneven electrification in a weld line portion. In a porthole tube prepared by the porthole method, since a component of aluminum in a seam portion thereof is different from that of other portions, a work function in the seam portion is different from that of other portions. Therefore, at a portion where the porthole tube and the electric charge generating substance contact with each other, an injection of an electric charge from the porthole tube to the electric charge generating layer becomes easy so that the electric charge is not retained there to decrease a surface potential thereof. As a result, a portion corresponding to the seam of the porthole tube will appear as an image defect in the streak pattern.

For this reason, in order that the porthole tube is used as the electrically conductive support, it is necessary to suppress the injection of the electric charge from the porthole tube to the electric charge generating layer not only by decreasing a concentration of the electric charge generating substance at an interface between the porthole tube and the photosensitive layer but also by reducing a contact area between the porthole tube and the electric charge generating substance.

As a prior art, a single-layer type electophotographic photoreceptor in which a weld line does not appear in an image and also sensitivity thereof has improved in comparison with that of a conventional one is disclosed in Japanese Unexamined Patent Publication JP-A 2000-250242 (2000).

In the single-layer type electrophotographic photoreceptor, since the electric charge generating substance is uniformly dispersed in a low concentration within an entire photosensitive layer, the contact area between the porthole tube and the electric charge generating substance has come to be small. By this feature, a potential fall in the seam portion of the porthole tube becomes small enough to be neglected and, as a result, the weld line will not appear in the image.

However, in recent years, high sensitivity of the electrophotographic photoreceptor has been requested. In order to attain the high sensitivity of the single-layer type electrophotographic photoreceptor, it is required to enhance a concentration of the electric charge generating substance in the photosensitive layer; however, when the concentration of the electric charge generating substance is brought to be high, a distance between the electric charge generating substance and the electric charge transferring substance becomes small. As a result, resistance of the photosensitive layer is decreased whereupon a function as the photosensitive layer can not appropriately be performed. Under these circumstances, an upper limit is put on a quantity of the electric charge generating substance to be contained in a single-layer type photosensitive layer whereupon it is difficult to allow the sensitivity of the single-layer type electrophotographic photoreceptor to be enhanced.

In contrast, in the multi-layered type electrophotographic photoreceptor, since the electric charge generating substance and the electric charge transferring substance do not exist in a same layer, even when the concentration of the electric charge generating substance is enhanced, the resistance of an entire photosensitive layer is not decreased. Further, even when in a repeated use, since an outermost layer thereof is the electric charge transferring layer which has a certain extent of strength and thickness, the multi-layered type electrophotographic photoreceptor has an advantage that it can maintain stable characteristics and the like.

However, in the multi-layered type electrophotographic photoreceptor, since a high concentration of the electric charge generating substance must be dispersed in the electric charge generating layer in relation with sensitivity thereof, the contact area between the electrically conductive support and the electric charge generating substance becomes large and, accordingly, the multi-layered type electrophotographic photoreceptor has a drawback that an injection of the electric charge from the electrically conductive support to the electric charge generating layer becomes easy to occur. For these reasons, it is a present situation that, regardless of a low cost of the porthole tube, since the seam thereof becomes a cause of the image defect, the porthole tube has not been used in the multi-layered type electrophotographic photoreceptor.

### SUMMARY OF THE INVENTION

Accordingly, an object of the invention is to provide a multi-layered type electrophotographic photoreceptor in which a low-cost porthole tube is used as an electrically conductive support and an electrophotographic apparatus in which the electrophotographic photoreceptor described above is used.

The invention relates to an electrophotographic photoreceptor comprising an electrically conductive support and a multi-layered type photosensitive layer including at least an electric charge generating layer and an electric charge transferring layer on the electrically conductive support, wherein the electrically conductive support is a porthole tube having a seam extending in a direction of an axis thereof and wherein an undercoat layer containing an inorganic pigment is provided between the electrically conductive support and the photosensitive layer.

According to the invention, since the undercoat layer is provided between the porthole tube and the photosensitive layer, an electric charge is hard to be injected from the porthole tube to the electric charge generating layer at a contact portion with the electric charge generating substance. Owing to this feature, a surface potential of the photosensitive layer is not decreased, so that the porthole tube can be used as the electrically conductive support in the multi-layered type electrophotographic photoreceptor. Further, since the undercoat layer contains the inorganic pigment, resistance of the undercoat layer is suppressed.

According to the invention, since the undercoat layer is provided between the porthole tube and the photosensitive layer, the electric charge is hard to be injected from the porthole tube to the electric charge generating layer at the contact portion with the electric charge generating substance. Accordingly, the porthole tube can be used as the electrically conductive support in the multi-layered type electrophotographic photoreceptor. Further, since the undercoat layer contains the inorganic pigment, resistance of the undercoat layer is suppressed. Accordingly, since a film thickness of the undercoat layer can be thick to some extent, a defect on the porthole tube can surely be covered. From these features, the multi-layered type electrophotographic photoreceptor which does not generate an image defect even by using the porthole tube and has photographic characteristics that are stable and high sensitive even at the time of repeated use can be provided.

Further, in the invention it is preferable that the inorganic pigment contained in the undercoat layer is titanium oxide.

According to the invention, since the inorganic pigment contained in the undercoat layer is titanium oxide, resistance of the undercoat layer is suppressed.

Further, according to the invention, since the inorganic pigment contained in the undercoat layer is titanium oxide, resistance of the undercoat layer is suppressed and, since the film thickness of the undercoat layer can be thick, the defect on the surface of the porthole tube can surely be covered. Therefore, the multi-layered type electrophotographic photoreceptor which does not generate the image defect even by using the porthole tube and has photographic characteristics that are stable and high sensitive even at the time of repeated use can be provided.

In the invention it is preferable that the inorganic pigment contained in the undercoat layer is zinc oxide.

In the invention it is preferable that the inorganic pigment contained in the undercoat layer is tin oxide.

In the invention it is preferable that the inorganic pigment contained in the undercoat layer is indium oxide.

In the invention it is preferable that the undercoat layer contains the inorganic pigment and a binding resin and a weight ratio of the inorganic pigment to the binding resin is from 50/50 to 98/2.

In the invention it is preferable that the undercoat layer contains the inorganic pigment and the binding resin and the weight ratio of the inorganic pigment to the binding resin is from 50/50 to 95/5.

According to the invention, since the weight ratio of the inorganic pigment to the binding resin is from 50/50 to 98/2 and preferably from 50/50 to 95/5, a coating solution for the undercoat layer optimum for preparing a highly sensitive multi-layered type electrophotographic photoreceptor can be obtained whereupon the undercoat layer which can surely cover the image defect to be caused by the seam of the porthole tube can be formed.

Further, according to the invention, since the weight ratio of the inorganic pigment to the binding resin is from 50/50 to 98/2 and preferably from 50/50 to 95/5, an optimum coating solution for the undercoat layer can be obtained whereupon the undercoat layer which can surely cover the image defect caused by the seam of the porthole tube can be formed. Therefore, the multi-layered type electrophotographic photoreceptor which does not generate the image defect even by using the porthole tube and has photographic characteristics that are stable and high sensitive even at the time of repeated use can be provided.

Further, the invention is characterized in that the binding resin is an alcohol-soluble polyamide resin.

According to the invention, since the alcohol-soluble polyamide resin is used as the binding resin, adhesiveness between the undercoat layer and the porthole tube can be enhanced.

Further, according to the invention, since the binding resin in the undercoat layer is the alcohol-soluble polyamide resin, the undercoat layer which is excellent in adhesiveness with the porthole tube and has an appropriate flexibility can be obtained. Therefore, the multi-layered type electrophotographic photoreceptor which does not generate the image defect even by using the porthole tube and has photographic characteristics that are stable and high sensitive even at the time of repeated use can be provided.

Further, the invention is characterized in that a film thickness of the undercoat layer is in a range of from 0.5 μm to 5 μm.

According to the invention, since the film thickness of the undercoat layer is in a range of from 0.5 μm to 5 μm, an injection of an electric charge from the porthole tube to the electric charge generating layer can effectively be prevented.

Further, according to the invention, since the film thickness of the undercoat layer is in a range of from 0.5 μm to 5 μm, a defect on a seam portion of the porthole tube can effectively be covered. Therefore, the multi-layered type electrophotographic photoreceptor which does not generate an image defect even by using the porthole tube and has photographic characteristics that are stable and high sensitive even at the time of repeated use can be provided.

Further, the invention relates to an electrophotographic apparatus which is characterized in that the electrophotographic apparatus comprises the electrophotographic photoreceptor wherein the electrophotographic photoreceptor is exposed to a semiconductor laser light or an LED light.

According to the invention, the electrophotographic apparatus which can output an image having no image defect and also can output the image having a stable quality even at the time of repeated use can be provided.

Further, according to the invention, since the electrophotographic apparatus which is characterized in that the electrophotographic apparatus comprises the electrophotographic photoreceptor wherein the electrophotographic photoreceptor is exposed to the semiconductor laser light or the LED light, the electrophotographic apparatus which can output the image having no image defect and also can output the image having the stable quality even at the time of repeated use can be provided.

### BRIEF DESCRIPTION OF THE DRAWINGS

Other and further objects, features, and advantages of the invention will be more explicit from the following detailed description taken with reference to the drawings wherein:

FIG. 1 is a cross-sectional view of a portion of a multi-layered type electrophotographic photoreceptor as an embodiment of the invention;

FIG. 2 is a perspective view of a porthole tube; and

FIG. 3 is a diagram showing an electrophotographic apparatus provided with an electrophotographic photoreceptor of the invention.

### DETAILED DESCRIPTION OF THE PREFERRED EMBODIMENTS

Now referring to the drawings, preferred embodiments of the invention are described below.

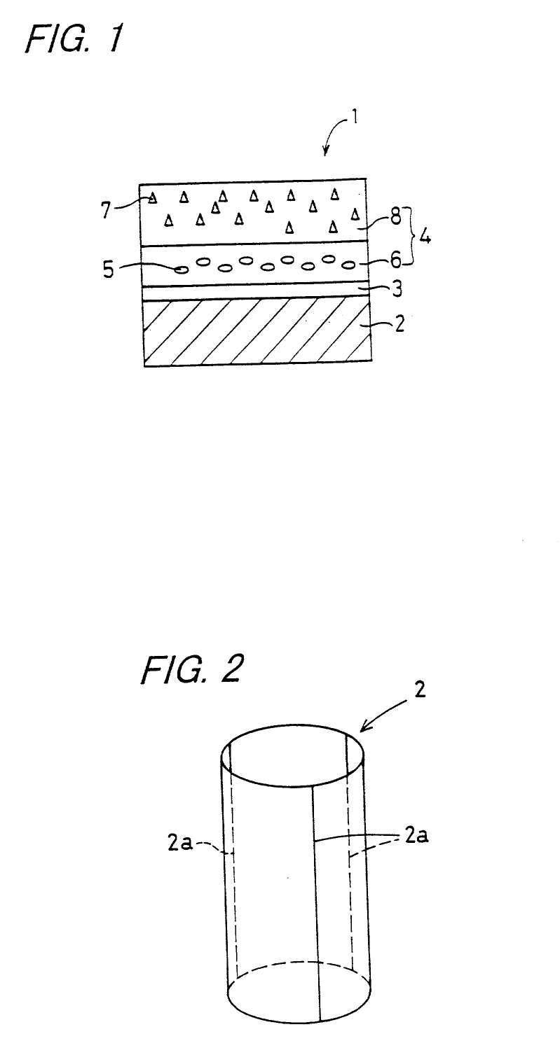

FIG. 1 is a cross-sectional view of a portion of a multi-layered type electrophotographic photoreceptor 1 as an embodiment of the invention. The electrophotographic photoreceptor 1 comprises a porthole tube 2, an undercoat layer 3 formed on a surface of the porthole tube 2 and a photosensitive layer 4 formed on a surface of the undercoat layer 3. Further, the photosensitive layer 4 comprises a laminate structure comprising an electric charge generating layer 6 containing an electric charge generating substance 5 and an electric charge transferring layer 8 containing an electric charge transferring substance 7.

FIG. 2 is a perspective view of a porthole tube 2. Firstly, the porthole tube 2 is described below. As a material for use in the porthole tube 2, aluminum or aluminum alloy such as a 1000 (pure aluminum) type, a 3000 (Al—Mn) type, a 5000 (Al—Mg) type, a 6000 (Al—Mg—Si) type and the like is used.

The porthole tube 2 used these materials is prepared by steps of extrusion processing, drawing processing (or ironing processing), cutting-off processing and cutting processing on an outer surface. Respective steps of these processing are performed under conditions within a scope of conventional ones.

The extrusion processing is a porthole method which is excellent in an extent of thickness deviation and capability of being in a small thickness. In this extrusion processing, a seam portion 2a is formed on the porthole tube 2, extending in a direction of an axis thereof. Further, the drawing processing is performed in order to obtain the porthole tube 2 of high accuracy. A processing rate of such drawing processing (a ratio of length after being processed to that before being processed) is ordinarily in a range of from 1.1 to 1.4. This drawing processing is performed such that a plug and a die are provided in an inner-diameter side and an outer-diameter side, respectively, and, then, the inner-diameter side and the outer-diameter side are simultaneously drawn; on this occasion, a poor balance of a processing rate between the inner-diameter side and the outer-diameter will cause residual stress.

The cutting-off processing is performed in order to allow the porthole tubes 2 to have a same predetermined length with one another; on this occasion, a burr which is sometimes generated at the time of the cutting-off processing remains on an edge of an outside end or an inside end of an end surface generated by this cutting-off processing and there is a risk that the thus-generated burr may be a hindrance to succeeding processing. Therefore, as a step of the cutting processing on the outer surface after the cutting-off processing, C-shaped chamfering of about 0.2 mm is performed on the outer side and the inner side of the end surface of the porthole tube 2.

Thickness of the porthole tube 2 is in a range of preferably 2 mm or less and more preferably 1 mm or less from the points of cost and allowing weight of the entire electrophotographic apparatus to be small. Further, it is necessary from the points of performing the cutting processing that a deviation of the thickness thereof is preferably 0.05 mm or less and more preferably 0.03 mm or less.

Next, the undercoat layer 3 is described below. The undercoat layer 3 is formed for the purpose of eliminating a difference between a work function of the seam portion 2a and that of other portions of the porthole tube 2 to prevent the electric charge from being injected from the porthole tube 2 to the electric charge generating layer 6 at a contact portion between the porthole tube 2 and the electric charge generating substance 5. By providing this undercoat layer 3, an image defect to be caused by the seam portion 2a of the porthole tube 2 will not be generated and, at the same time, coating of any other defect on the surface of the porthole tube 2, improvement of an electrostatic property of the photosensitive layer, enhancement of adhesiveness between the porthole tube 2 and the photosensitive layer 4, and the like can be attained.

The undercoat layer 3 is formed by coating a coating solution, which is prepared by mixing an binding resin and an inorganic pigment in a solvent, on the porthole tube 2. As a method of mixing and dispersing the binding resin and the in organic pigment in the solvent to prepare the coating solution, a method using a ball mill, a sand grinder, a paint shaker, an ultrasonic dispersing apparatus or the like is mentioned. Further, as a method of applying the thus-dispersed and prepared coating solution for the undercoat layer on the porthole tube 2, a spray method, a vertical type ring method, an immersion application method or the like is mentioned.

A film thickness of the undercoat layer 3 is in a range of preferably from 0.01 μm or more to 10 μm or less and more preferably from 0.5 μm or more to 5 μm or less. The reason of setting the film thickness of the undercoat layer 3 as being 0.01 μm or more is that, when the thickness is less than 0.01 μm, the defects on the surface of the porthole tube 2 can not fully be covered whereupon a uniform surface feature can not be obtained and, accordingly, injection of the electric charge from the porthole tube 2 to the electric charge generating layer 6 can not effectively be prevented thereby causing decreasing of the electrostatic property. Further, the reason of setting the thickness of the undercoat layer 3 as being 10 μm or less is that, when it is more than 10 μm, film-forming becomes difficult whereupon mechanical strength of the undercoat layer 3 becomes deteriorated, and also, since resistance of the undercoat layer 3 becomes large, transfer of the electric charge generated by light irradiation is hindered whereupon residual potential is increased.

As the inorganic pigment to be contained in the undercoat layer 3, titanium oxide is used from the standpoint of excellency in a dispersing property into the coating solution for the undercoat layer 3 and excellency in stability of the coating solution in a dispersed state.

Titanium oxide is added for the purpose of decreasing the resistance of the undercoat layer 3. It goes without saying that the undercoat layer 3 can be formed by adding the binding resin alone without concurrently adding titanium oxide, but when the undercoat layer 3 is formed by adding the binding resin alone and, generation of an image defect to be caused by the seam portion 2a of the porthole tube 2 is tried to be prevented by the thus-formed undercoat layer 3, the thickness of the undercoat layer 3 becomes large. As a result, the resistance of the undercoat layer 3 itself becomes large whereupon, at the time of repeated use, the residual potential is increased. In order to alleviate such a situation as described above, it is necessary to bring the thickness of the undercoat layer 3 to be small; however, when the thickness of the undercoat layer 3 becomes small, the defect present on the porthole tube 2 can not fully be covered to the contrary, or a laser light used as a light source and the porthole tube 2 cause interference therebetween to generate a new image defect (moiré). Therefore, the undercoat layer 3 having an optimum resistance while having a certain extent of thickness can be formed by allowing titanium oxide to be contained therein.

A shape of titanium oxide may be of a granular shape, but is particularly preferably of an elongated needle shape such as a rod shape, a column shape, a spindle shape and the like. When the undercoat layer 3 formed by using titanium oxide in a granular shape and that formed by using titanium oxide in a needle shape are compared with each other on a basis of same titanium oxide content, the undercoat layer 3 formed by using titanium oxide in the needle shape has a lower resistance than the other. This feature is considered as that, since needle shapes of titanium oxide have a relatively larger opportunity to meet with each other than granular shapes of titanium oxide, titanium in the needle shape can perform an effect of decreasing the resistance of the undercoat layer 3 more than the other. Therefore, in a case in which titanium oxide in the needle shape is used, even when a content thereof is decreased, the thickness of the undercoat layer 3 can be larger whereupon the undercoat layer 3, which has such resistance as does not cause increasing of the residual potential at the time of repeated use, can infallibly cover the surface defect of the porthole tube 2 and has an excellent surface flatness character, can be obtained.

Further, by the capability of decreasing the content of titanium oxide, film strength of the undercoat layer 3 and adhesiveness thereof with the porthole tube 2 can be enhanced, characteristics thereof relative to an environment in which the undercoat layer 3 is used can be improved and, particularly, increasing of the residual potential at a low temperature and low relative humidity can be suppressed. Further, since deterioration of electric characteristics and image characteristics to be caused by the repeated use over a long period of time can be decreased more by using titanium oxide in the needle shape than by using titanium oxide in the granular shape, the electrophotographic photoreceptor 1 having a better stability can be obtained by using titanium oxide in the needle shape.

The surface of titanium oxide may previously be treated by a coupling agent or the like. By treating the surface thereof by the coupling agent, titanium oxide becomes hard to be coagulated and the coating solution for the undercoat layer which is hard to be gelled can be prepared whereupon a dispersing property and storage stability of the coating solution are enhanced. As a result, a uniform undercoat layer 3 can be obtained and, accordingly, a reduction of a production cost for preparing the undercoat layer 3 can be attained.

The addition quantity of the coupling agent is optionally selected in accordance with a type or a shape of titanium oxide, but is preferably in a range of from 0.01% by weight to 30% by weight and more preferably from 0.1% by weight to 20% by weight based on the total weight of titanium oxide. The reason for setting such a range as described above is that, when the addition quantity thereof is less than 0.01% by weight based on the total weight of titanium oxide, an effect of the surface treatment by the coupling agent can not be obtained, and also, when the addition quantity thereof is more than 30% by weight based on the total weight of titanium oxide, the effect of the surface treatment by the coupling agent is hardly changed.

Examples of crystal forms of titanium oxide include an anatase type, a rutile type, an amorphous type and the like, and any crystal form of titanium oxide may be used. Further, titanium oxide to be used is not limited to any one crystal form but mixtures of different crystal forms are permitted.

As the binding resin to be contained in the undercoat layer 3, a polyamide resin is used, in view of that the resin does not dissolve or swell in a solvent which is used in the photosensitive layer 4 to be formed on the undercoat layer 3, the resin has a good adhesiveness with the porthole tube 2, the resin can impart the undercoat layer 3 with appropriate flexibility, the resin is excellent in imparting the coating solution with dispersion stability and storage stability and the like. Among other things, an alcohol-soluble nylon is preferable. Examples of alcohol-soluble nylons include a copolymer nylon (formed by copolymerizing 6-nylon, 66-nylon, 610-nylon, 11-nylon, 12-nylon or the like) and a chemically modified nylon (N-alkoxy methyl group-modified nylon, N-alkoxy ethyl group-modified nylon or the like).

As a mixing ratio of titanium oxide to the polyamide resin, titanium oxide/polyamide resin is preferably from 50/50 to 98/2 and more preferably from 50/50 to 95/5. On a basis of 100 parts of a mixture of titanium oxide and the polyamide resin, the reason of setting the polyamide resin as being 50 parts or less is because, when the polyamide resin is more than 50 parts, there occurs a problem that a viscosity of the coating solution is increased, a coating property or repeated-use characteristics thereof are deteriorated or the like. Further, the reason of setting the polyamide resin as being 2 parts or more is because, when the polyamide resin is less than 2 parts, there occurs another problem that, titanium oxide becomes more than 98 parts whereupon deteriorations of the repeated-use characteristics, a dispersing property and the like are brought about by a decrease of resistance of the undercoat layer 3.

A ratio of a solid content against a solvent is preferably from 5% to 15%. The reason of setting the ratio as being 5% or more is because, when the solid content is less than 5%, a wet film thickness enough to obtain a predetermined thickness becomes large whereupon it becomes necessary to use a solvent having a low boiling point in view of productivity but, on this occasion, due to a fast drying rate of the solvent, there occurs a brushing phenomena. Further, the reason of setting the solid content as being 15% or less is because, when the solid content is more than 15%, the viscosity of the coating solution for the undercoat layer 3 is increased whereupon a long-term stability of the coating solution is deteriorated.

As the inorganic pigment, zinc oxide, tin oxide, indium oxide or the like may be used, instead of titanium oxide.

As the binding resin, polyethylene, polypropylene, polystyrene, an acrylic resin, a vinyl chloride resin, a vinyl acetate resin, polyurethane, an epoxy resin, a polyester, a melamine resin, a silicone resin, polyvinyl butyral, polyamide or the like may be used, or a copolymer having at least 2 repeating units of any one of these resins may be used, instead of the polyamide resin. Further, casein, gelatin, polyvinyl alcohol, ethyl cellulose or the like may be used.

Next, the electric charge generating layer 6 is described below. The electric charge generating layer 6 is formed by steps of crushing the electric charge generating substance 5 as well as the binding resin, dispersing the thus-crushed substance and resin in an appropriate solvent to prepare a coating solution for the electric charge generating layer 6 and coating the thus-prepared coating solution on a surface of the undercoat layer 3. As a method of preparing the coating solution for the electric charge generating layer 6 and a method of forming the electric charge generating layer 6 by applying the coating solution on the undercoat layer 3, same methods as described in the undercoat layer 3 can be adopted. Further, the electric charge generating layer 6 may be formed by a gas phase deposition method such as a vacuum deposition method, spattering, CVD or the like.

A film thickness of the electric charge generating layer 6 is in a range of preferably from 0.05 μm to 5 μm and more preferably from 0.1 μm to 1 μm.

As the electric charge generating substance, any of the organic and inorganic pigments and organic dyes may be used so long as it absorbs light to generate a free electric charge; however, in the embodiments according to the invention, an organic photoconductive compound such as an organic pigment, an organic dye or the like is used.

Examples of the organic pigments include a phthalocyanine-type compound, an azo-type compound, a quinacridone-type compound, a polycyclic quinone-type compound, a perylene-type compound and the like. Among these organic pigments, the phthalocyanine-type compound is preferable. Among other things, a compound which can bring about a particularly favorable sensitivity characteristics, electrostatic characteristics and repeated-use characteristics is a titanyl phthalocyanine compound. Examples of the organic dyes include a thiapyrylium salt, a squarylium salt and the like.

Examples of inorganic pigments include selenium and an alloy thereof, arsenic-selenium, cadmium sulfide, zinc oxide, amorphous silicon and other inorganic photoconductive substances.

Examples of the binding resins for use in the electric charge generating layer 6 include a polyarylate, polyvinyl butyral, polycarbonate, polyester, polystyrene, polyvinyl chloride, phenoxy, epoxy, silicone, polyacrylate and the like.

Examples of the solvents for use in the electric charge generating layer 6 include isopropyl alcohol, cyclohexanone, cyclohexane, toluene, xylene, acetone, methyl ethyl ketone, tetrahydrofuran, dioxane, dioxolan, ethyl cellosolve, ethyl acetate, methyl acetate, dichloromethane, dichloroethane, monochlorobenzene, ethylene glycol dimethyl ether and the like, but other solvents may be permitted, for example, any one of solvents of any types such as alcohol type, ketone type, amide type, ester type, ether type, hydrocarbon type, chlorinated hydrocarbon type and aromatic type may be used. Among these solvents, in view of possibility of deterioration of sensitivity to be derived from crystal inversion at the time of crushing or milling the electric charge generating substance 5 and deterioration of characteristics based on a pot-life, it is preferable to use any member selected from the group consisting of cyclohexanone, 1,2-dimethoxyethane, methyl ethyl ketone and tetrahydroquinone none of which are likely to bring about the crystal inversion among themselves. Further, these solvents may be used each individually or in mixtures of two types or more.

Next, the electric charge transferring layer 8 is described. The electric charge transferring layer 8 is formed by the steps of dissolving or dispersing the electric charge transferring substance 7 together with the binding resin in an appropriate solvent to prepare a coating solution for the electric charge transferring layer 7 and applying the thus-prepared coating solution on a surface of the electric charge generating layer 6.

A method for preparing the coating solution for the electric charge transferring layer 8 may be a method in which one or more types of the electric charge transferring substances 7 and the binding resin are weighted and, then, dissolved in a predetermined quantity of the solvent to prepare the coating solution, however, preferable is another method in which firstly the binding resin is dissolved in the solvent and, thereafter, the electric charge transferring substance 7 is added to the resultant solution and dissolved therein. According to the latter method, dispersion of molecules of the electric charge transferring substance 7 to the binding resin is enhanced whereupon inherent and local crystallization of the electric charge transferring substance 7 in the electric charge transferring layer 8 is suppressed. Therefore, the electrophotographic photoreceptor 1 which has potential stability at the time of repeated use, favorable image characteristics and the like, and, further, has been enhanced in initial sensitivity can be obtained.

As a method of forming the electric charge transferring layer 8 by applying such a coating solution as obtained above on the electric charge generating layer 6, the same methods as those in the undercoat layer 3 may be adopted; however, in view of the productivity or production cost, the immersion coating method is preferable.

A film thickness of the electric charge transferring layer 8 is in a range of from 10 μm to 50 μm and preferably from 10 μm to 35 μm.

As the binding resin and the solvent for use in the electric charge transferring layer 8, same ones as those in the electric charge generating layer 6 can be used. A quantity of the binding resin is, based on 100 parts by weight of the electric charge transferring substance 7, in a range of from 50 parts by weight to 300 parts by weight and preferably from 100 parts by weight to 200 parts by weight.

Further, in the electric charge transferring layer 8, an antioxidant, a plasticizer, a leveling agent may optionally be added. As the leveling agent, any one of silicone oils, a polymer having a perfluoroalkyl group in a side chain thereof, an oligomer and the like can be used. A quantity of the leveling agent to be used is preferably 1 part by weight or less based on 100 parts by weight of the binding resin.

Hereinafter, the invention is described with reference to examples that follow but the invention is by no means limited thereto.

### (EXAMPLE 1)

An JIS 3003 alloy was subjected to extrusion processing and drawing processing by a porthole method to form a thin cylinder and, then, the thus-formed thin cylinder was cut off to prepare a porthole tube having an outer diameter of 30.0 mm, an inner diameter of 29.0 mm, a length of 326.3 mm and a thickness deviation of 0.03 mm.

Next, a mixture solution having components described below was subjected to dispersion processing by a paint shaker for 10 hours to prepare a coating solution for an undercoat layer. Film-forming processing was performed by applying the thus-prepared solution on an outer surface of the porthole tube which has previously been prepared as above by means of immersion coating processing such that a film having a thickness of 1 μm was formed to form an undercoat layer.

(Coating Solution for Undercoat Layer)

Titanium oxide (Al₂O₃, ZrO₂-surface treated, dendritic rutile-type; titanium content: 85%) (TTO-MI-1, available from Ishihara Sangyo Kaisha, Ltd.): 3 parts by weight

Alcohol-soluble nylon resin (CM-8000, available from Toray Industries Inc.): 3 parts by weight

Methanol: 35 parts by weight

1,3-dioxolan: 65 parts by weight.

Next, a mixture solution having components described below was dispersed by a ball mill for 72 hours to prepare a coating solution for an electric charge generating layer. Film-forming processing was performed by applying the thus-prepared solution on a surface of the undercoat layer which has previously been prepared as above by means of immersion coating processing such that a film having a thickness of 0.2 μm was formed to form an electric charge generating layer.

(Coating Solution for Electric Charge Generating Layer)

Butyral resin (S-LEC BL-2, available from Sekisui Chemical Co., Ltd.): 10 parts by weight

Dimethoxy ethane: 1400 parts by weight

Titanyl phthalocyanine, a compound having a structural formula (I) described below: 15 parts by weight.

Next, a mixture solution having components described below was mixed and dissolved to prepare a coating solution for an electric charge transferring layer. Film-forming processing was performed by applying this coating solution on a surface of the electric charge generating layer which has previously been prepared by means of an immersion coating method such that a film having a thickness of 20 μm was formed and thus-formed film was dried at 120° C. for one hour to form an electric charge transferring layer thereby obtaining an electrophotographic photoreceptor.

(Coating Solution of Electric Charge Transferring Layer)

Electric charge transferring substance having a structural formula (II) described below: 100 parts by weight

Z-type polycarbonate resin expressed by a structural formula (III) described below (Z200, available from Mitsubishi Engineering-Plastics Corporation): 150 parts by weight

Silicone oil: 0.02 part by weight

THF: 1000 parts by weight

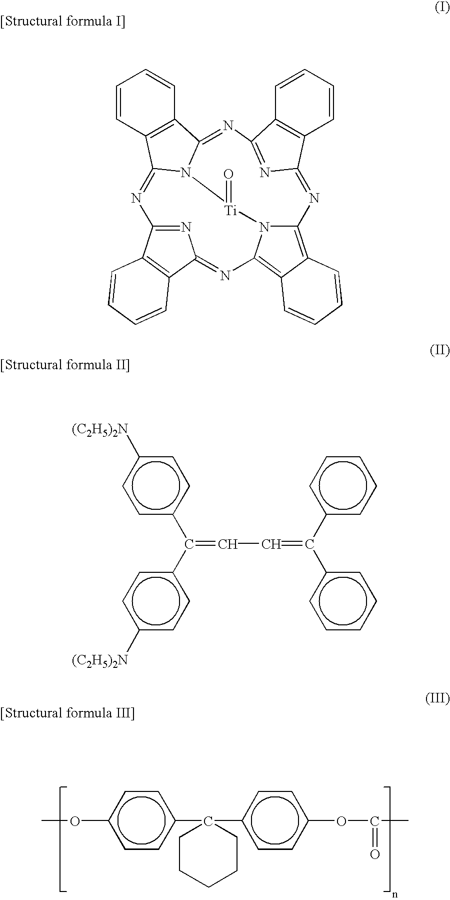

An evaluation of an image by using a halftone image and an evaluation of repeating characteristics were performed on a multi-layered type electrophotographic photoreceptor which had previously been prepared above by means of a digital copying machine (AR-N200, available from Sharp Co., Ltd.) whereupon the image without any image defect was obtained and none of increase of a residual potential and decrease of an electrostatic potential was found in the repeating characteristics to show favorable electrophotographic characteristics.

### (EXAMPLE 2)

An electrophotographic photoreceptor was prepared in the same manner as in Example 1 except that the coating solution for the undercoat layer was prepared by using components described below. Evaluations thereof were performed in the same manner as in Example 1.

(Coating Solution for Undercoat Layer)

Titanium oxide (Al₂O₃, ZrO₂-surface treated, dendritic rutile-type; titanium content: 85%) (TTO-MI-1, available from Ishihara Sangyo Kaisha, Ltd.): 9.5 parts by weight

Alcohol-soluble nylon resin (CM-8000, available from Toray Industries Inc.): 0.5 part by weight

Methanol: 35 parts by weight 1,3-dioxolan: 65 parts by weight.

As a result of the evaluations, there was no defect in a halftone image and none of increase of residual potential, decrease of electrostatic potential and the like were found to show favorable electrophotographic characteristics.

### (COMPARATIVE EXAMPLE 1)

An electrophotographic photoreceptor was prepared in the same manner as in Example 1 except that a coating solution for an undercoat layer was prepared by using components described below and then the undercoat layer having a film thickness of 1.0 μm was formed by using the thus-prepared coating solution. Evaluations thereof were performed in the same manner as in Example 1.

(Coating Solution for Undercoat Layer)

Alcohol-soluble nylon resin (CM-8000, available from Toray Industries Inc.): 6 parts by weight

Methanol: 35 parts by weight

1,3-dioxolan: 65 parts by weight.

As a result of the evaluations, though a weld line did not appear at a portion corresponding to a seam of the porthole tube in a halftone image, a marked increase of residual potential was noticed in an evaluation of the repeating characteristics.

### (COMPARATIVE EXAMPLE 2)

An electrophotographic photoreceptor was prepared in the same manner as in Example 1 except that an undercoat layer having a film thickness of 0.3 μm was formed by using the same coating solution for the undercoat layer as in Comparative Example 1. Evaluations thereof were performed in the same manner as in Example 1.

As a result of the evaluations, it was noticed that a weld line appeared in a halftone image as an image defect and, further, an interference (moiré phenomena) caused by an exposure light source was generated to appear as a defect in the image.

### (COMPARATIVE EXAMPLE 3)

An electrophotographic photoreceptor was prepared in the same manner as in Example 1 except that an undercoat layer was not provided. Evaluations thereof were performed in the same manner as in Example 1.

As a result of the evaluations, a weld line appeared at a portion corresponding to a seam of the porthole tube in a halftone image as an image defect and, further, an interference (moiré phenomena) caused by an exposure light source was generated to appear as a defect in the image. Furthermore, a minute scratch, which was formed at the time of a cleaning operation, present on the electrically conductive support appeared in the image as an image defect. In addition, a marked increase of residual potential was noticed in an evaluation of repeating characteristics.

### (COMPARATIVE EXAMPLE 4)

As shown below, an electrophotographic photoreceptor was prepared in the same manner as in Example 1 except that an undercoat layer was prepared by using zinc oxide instead of titanium oxide. Evaluations thereof were performed in the same manner as in Example 1.

(Coating Solution for Undercoat Layer)

Zinc oxide: (SC-18, available from Sakai Chemical Industry Co., Ltd.): 3 parts by weight

Alcohol-soluble nylon resin (CM-8000, available from Toray Industries Inc.): 3 parts by weight

Methanol: 35 parts by weight

1,3-dioxolan: 65 parts by weight.

As a result of the evaluations, though a weld line did not appear in a halftone image, it was noticed that a black attenuation became large at the time of repeated use resulting in a decrease of electrostatic potential. Further, this coating solution was poor in storage stability and gelation thereof was noticed 3 days after it was prepared.

### (COMPARATIVE EXAMPLE 5)

An electrophotographic photoreceptor was prepared in the same manner as in Example 1 except that a coating solution for an undercoat layer was prepared by using components described below. Evaluations thereof were performed in the same manner as in Example 1.

(Coating Solution for Undercoat Layer)

Titanium oxide (Al₂O₃, ZrO₂-surface treated, dendritic rutile-type; titanium content: 85%) (TTO-MI-1, available from Ishihara Sangyo Kaisha, Ltd.): 4 parts by weight

Alcohol-soluble nylon resin (CM-8000, available from Toray Industries Inc.): 6 parts by weight

Methanol: 35 parts by weight

1,3-dioxolan: 65 parts by weight.

As a result of the evaluations, though a weld line did not appear in a halftone image, an increase of residual potential was generated in repeating characteristics.

### (COMPARATIVE EXAMPLE 6)

An electrophotographic photoreceptor was prepared in the same manner as in Example 1 except that a coating solution for an undercoat layer was prepared by using components described below. Evaluations thereof were performed in the same manner as in Example 1.

(Coating Solution for Undercoat Layer)

Titanium oxide (Al₂O₃, ZrO₂-surface treated, dendritic rutile-type; titanium content: 85%) (TTO-MI-1, available from Ishihara Sangyo Kaisha, Ltd.): 9.9 parts by weight

Alcohol-soluble nylon resin (CM-8000, available from Toray Industries Inc.): 0.1 part by weight

Methanol: 35 parts by weight

1,3-dioxolan: 65 parts by weight.

A uniform undercoat layer was unable to be prepared by this coating solution for the undercoat layer.

### (COMPARATIVE EXAMPLE 7)

An electrophotographic photoreceptor was prepared in the same manner as in Example 1 except that, as shown below, PMMA was used as a binding resin. Evaluations thereof were performed in the same manner as in Example 1.

(Coating Solution for Undercoat Layer)

Titanium oxide (Al₂O₃, ZrO₂-surface treated, dendritic rutile-type; titanium content: 85%) (TT O-MI-1, available from Ishihara Sangyo Kaisha, Ltd.): 3 parts by weight

PMMA (Mw: 30000): 3 parts by weight

Methanol: 35 parts by weight

1,3-dioxolan: 65 parts by weight.

As a result of the evaluations, though a weld line did not appear in a halftone image, a slight increase of residual potential was noticed in repeating characteristics. Further, this coating solution was poor in storage stability and gelation thereof was noticed 3 days after it was prepared.

### (COMPARATIVE EXAMPLE 8)

An electrophotographic photoreceptor was prepared in the same manner as in Example 1 except that an undercoat layer having a film thickness of 0.4 μm was formed. Evaluations thereof were performed in the same manner as in Example 1.

As a result of the evaluations, a weld line appeared as an image defect at a portion corresponding to a seam of the porthole tube in a halftone image. An interference (moiré phenomena) was caused, and appeared as a defect in the image. Further, an decrease of an electrostatic property was large in an evaluation of the repeating characteristics.

### (COMPARATIVE EXAMPLE 9)

An electrophotographic photoreceptor was prepared in the same manner as in Example 1 except that an undercoat layer having a film thickness of 10 μm was formed. Evaluations thereof were performed in the same manner as in Example 1.

A wet film thickness became large at the time of forming the undercoat layer and, as a result, a sag appeared in the undercoat layer. Further, as a result of the evaluations, such a sag as described above in the undercoat layer appeared as an image defect in a halftone image and, also, in an evaluation of repeating characteristics, a marked increase of residual potential was noticed.

### (EXAMPLE 3)

An electrophotographic photoreceptor was prepared in the same manner as in Example 1 except that titanium oxide in a granular shape was used instead of dendritic titanium oxide used in Example 1. Evaluations thereof were performed in the same manner as in Example 1.

As a result of the evaluations, though a weld line did not appear in a halftone image, an increase of residual potential was noticed in repeating characteristics.

### (EXAMPLE 4)

An electrophotographic photoreceptor was prepared in the same manner as in Example 1 except that surface-untreated titanium oxide was used instead of surface-treated titanium oxide used in Example 1. Evaluations thereof were performed in the same manner as in Example 1.

As a results of the evaluations, though a weld line did not appear in a halftone image, a coating solution for an undercoat layer which had been prepared by using this surface-untreated titanium oxide was poor in a dispersion property whereupon unevenness of coating was generated at the time of preparing the electrophotographic photoreceptor. This unevenness of coating also appeared in the halftone image.

### (EXAMPLE 5)

An electrophotographic photoreceptor was prepared in the same manner as in Example 1 except that anatase-type titanium oxide was used instead of rutile-type titanium oxide used in Example 1. Evaluations thereof were performed in the same manner as in Example 1.

As a result of the evaluations, though a weld line did not appear in a halftone image, a coating solution for an undercoat layer which had been prepared by using this anatase-type titanium oxide was poor in a dispersion property whereupon unevenness of coating was generated at the time of preparing the electrophotographic photoreceptor. This unevenness of coating also appeared in the halftone image. Further, in this coating solution, a gelation phenomena was noticed two days after it was prepared.

Results of evaluations performed in Examples and Comparative Examples are shown in Table 1. In Table 1, Vo represents a surface potential (electrostatic potential) of the electrophotographic photoreceptor in a state in which light was not irradiated at all after the electrophotographic photoreceptor was electrostatically charged while VL represents a surface potential (residual potential) of the electrophotographic photoreceptor in a state after the electrophotographic photoreceptor was electrostatically charged and, subsequently, irradiated by light. Further, VH represents a surface potential of the electrophotographic photoreceptor in a state after a light quantity was set to be about half as large as that at the time of measuring the electrostatic potential and the residual potential and, then, light was irradiated with the thus-set light quantity.

TABLE 1

| | Image | | Potential characteristics | | | | | | |
|---|---|---|---|---|---|---|---|---|---|
| | Weld | | INI | | | Life | | | |
| | line | Others | Vo | VH | VL | Vo | VH | VL | Others |
| Example 1 | ◯ | ◯ | 590 | 332 | 40 | 588 | 350 | 60 | |
| Example 2 | ◯ | ◯ | 580 | 325 | 33 | 570 | 340 | 45 | |
| Comparative | ◯ | Density decreaseby by | 593 | 320 | 55 | 570 | 308 | 103 | |
| Example 1 | | repeated use | | | | | | | |
| Comparative | X | Moire | 583 | 320 | 42 | 556 | 281 | 29 | |
| Example 2 | | | | | | | | | |
| Comparative | X | Moire/Cleaning scratch | 532 | 263 | 31 | 507 | 221 | 32 | |
| Example 3 | | | | | | | | | |
| Comparative | ◯ | Fog generation by repeated | 584 | 327 | 45 | 497 | 267 | 35 | Gelation |
| Example 4 | | use | | | | | | | |
| Comparative | ◯ | Density decreaseby by | 587 | 342 | 48 | 614 | 384 | 98 | |
| Example 5 | | repeated use | | | | | | | |
| Comparative | — | — | — | — | — | — | — | — | Inabilityof preparation |
| Example 6 | | | | | | | | | (Inabilityof coating) |
| Comparative | ◯ | Density decreaseby by | 595 | 336 | 42 | 592 | 365 | 70 | Gelation |
| Example 7 | | repeated use | | | | | | | |
| Comparative | Δ | Moire | 578 | 321 | 36 | 564 | 322 | 33 | |
| Example 8 | | | | | | | | | |
| Comparative | ◯ | Sag | 595 | 348 | 52 | 630 | 389 | 113 | |
| Example 9 | | | | | | | | | |
| Example 3 | ◯ | Density decreaseby by | 592 | 326 | 53 | 598 | 372 | 84 | |
| | | repeated use | | | | | | | |
| Example 4 | ◯ | Coating unevenness | 593 | 329 | 42 | 595 | 360 | 72 | Poor dispersion Uneven |
| | | | | | | | | | coating |
| Example 5 | ◯ | Coating unevenness | 588 | 318 | 38 | 575 | 318 | 62 | Poor dispersion Uneven |
| | | | | | | | | | coating |

In the electric charge generating layer 6 of the electrophotographic photoreceptor 1, other than pigments and dyes described above, an electron receptive material such as a cyano compound (tetracyanoethylene, 7,7,8,8-tetracyanoquinodimethane or the like), any of quinones (anthraquinone, p-benzoquinone and the like), a nitro compound (2,4,7-trinitrofluorenone, 2,4,5,7-tetranitrofluorenone or the like) or the like may be added as a chemical sensitizer or other pigments such as a xanthene-type pigment, a thiazine dye, triphenyl methane-type pigment and the like may be added as a photosensitizer.

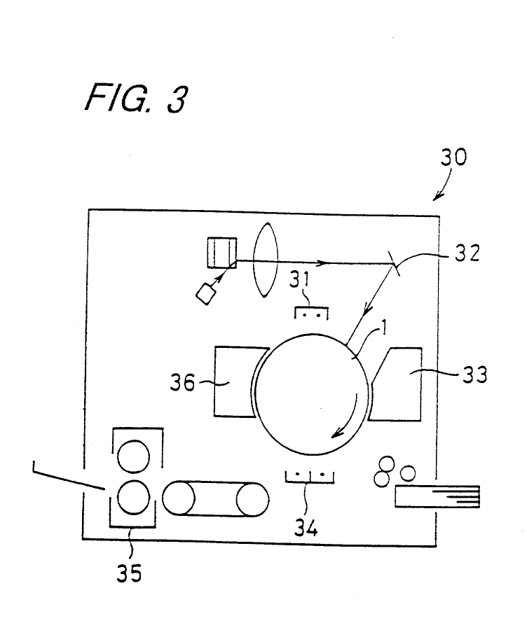

FIG. 3 is a structural diagram showing an electrophotographic apparatus 30 provided with an electrophotographic photoreceptor 1 of the invention. In the electrophotographic apparatus 30, cylindrical electrophotographic photoreceptor 1 of the invention is provided in a rotatable manner around which an electrostatically charging apparatus 31, an exposing apparatus 32, a developing apparatus 33, a transferring apparatus 34, a fixing apparatus 35 and a cleaning apparatus 36 are provided.

The electrophotographic photoreceptor 1 is electrostatically charged by the electrostatically charging apparatus 31 such that potential is uniform over an entire surface thereof, irradiated by a semiconductor laser light by means of the exposing apparatus 32 to decrease a quantity of electric charges electrostatically charged in a portion which is irradiated by the laser light thereby forming an electrostatic latent image. The thus-formed electrostatic latent image is developed by attaching a toner which is a powdery developing agent by means of the developing apparatus 33 to form a toner image on the electrophotographic photoreceptor 1. Next, the thus-formed toner image is transferred to a predetermined recording paper which has been transported by the transferring apparatus 34 and, then, fixed by the fixing apparatus 35. In such a manner as described above, an image is formed on the recording paper. The developing agent which remains on the photosensitive material 1 after the transferring has been performed is cleaned and static electricity thereof was eliminated by the cleaning apparatus 36, and steps after electrostatically charging by the electrostatically charging apparatus 31 are repeated. Further, the electrostatic latent image may be formed on the electrophotographic photoreceptor 1 by irradiating an LED (light-emitting diode) light, instead of the semiconductor laser light.

Latent image forming process of the electrophotographic photoreceptor 1 in the electrophotographic apparatus 30 is specifically described below. After a surface of the electrophotographic photoreceptor 1 provided with the photosensitive layer 4 is negatively charged by the electrostatic charging apparatus 31 and light having a wavelength which is absorbed by the electric charge generating substance is irradiated on the electric charge generating layer 6 by the exposing apparatus 32 to generate an electron and an electric charge of a hole in the electric charge generating layer 6. The hole is transferred onto a surface of the electrophotographic photoreceptor 1 by the electric charge transferring substance 7 contained in the electric charge transferring layer 8 to neutralize a negative charge on the surface. On the other hand, the electron in the electric charge generating layer 6 is transferred to a side of the cylindrical porthole tube 2 in which a positive electric charge was incited to neutralize the positive electric charge.

Since the electrophotographic apparatus 30 is provided with the electrophotographic photoreceptor 1 which does not generate an image defect and has stable and high sensitive electrophotographic property even at the time of repeated use, it can output an image of high quality having no image defect and stable even at the time of repeated use.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An electrophotographic photoreceptor comprising:
an electrically conductive support; and
a multi-layered type photosensitive layer including at least an electric charge generating layer and an electric charge transferring layer on the electrically conductive support,
wherein the electrically conductive support is a porthole tube having a seam extending in a direction of an axis thereof and wherein an undercoat layer containing an inorganic pigment is provided between the electrically conductive support and the photosensitive layer.

2. The electrophotographic photoreceptor of claim 1, wherein the inorganic pigment contained in the undercoat layer is titanium oxide.

3. The electrophotographic photoreceptor of claim 1, wherein the inorganic pigment contained in the undercoat layer is zinc oxide.

4. The electrophotographic photoreceptor of claim 1, wherein the inorganic pigment contained in the undercoat layer is tin oxide.

5. The electrophotographic photoreceptor of claim 1, wherein the inorganic pigment contained in the undercoat layer is indium oxide.

6. The electrophotographic photoreceptor of claim 1, wherein the undercoat layer contains the inorganic pigment and a binding resin and a weight ratio of the inorganic pigment to the binding resin is from 50/50 to 98/2.

7. The electrophotographic photoreceptor of claim 1, wherein the undercoat layer contains the inorganic pigment and the binding resin and the weight ratio of the inorganic pigment to the binding resin is from 50/50 to 95/5.

8. The electrophotographic photoreceptor of claim 1, wherein the undercoat layer contains the inorganic pigment and the binding resin and the binding resin is an alcohol-soluble polyamide resin.

9. The electrophotographic photoreceptor of claim 1, wherein a film thickness of the undercoat layer is in a range of from 0.5 μm to 5 μm.

10. An electrophotographic apparatus comprising:
the electrophotographic photoreceptor of claim 1, wherein the electrophotographic photoreceptor is exposed to a semiconductor laser light or an LED light.
